(19) United States
(12) Patent Application Publication
(10) Pub. No.: US 2009/0192792 A1
(43) Pub. Date: Jul. 30, 2009

(54) METHODS AND APPARATUSES FOR ENCODING AND DECODING AUDIO SIGNAL

(75) Inventors: Geon-hyoung LEE, Hwanseong-si (KR); Chul-woo LEE, Suwon-si (KR); Jong-hoon JEONG, Suwon-si (KR); Nam-suk LEE, Suwon-si (KR); Han-gil MOON, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 12/361,999

(22) Filed: Jan. 29, 2009

(30) Foreign Application Priority Data
Jan. 29, 2008 (KR) 10-2008-0009008

(51) Int. Cl. G10L 19/00

(52) U.S. Cl. 704/219; 704/E19.023

(57) ABSTRACT

Provided are methods and apparatuses for more efficiently encoding and decoding a high frequency band signal which is from an audio signal and which is greater than a predetermined threshold frequency. The method and apparatus for encoding the audio signal encodes a linear prediction coding (LPC) coefficient and gain information of a residual signal, which are generated by performing LPC analysis, thereby encoding a high frequency signal so as to have enhanced sound quality, while using less bits.

### CROSS-REFERENCE TO RELATED PATENT APPLICATION

This application claims the benefit of Korean Patent Application No. 10-2008-0009008, filed on Jan. 29, 2008, in the Korean Intellectual Property Office, the disclosure of which is incorporated herein in its entirety by reference.

### BACKGROUND OF THE INVENTION

1. Field of the Invention

Methods and apparatuses consistent with the present invention relate to encoding and decoding an audio signal, and more particularly, to methods and apparatuses for more efficiently encoding and decoding a signal which is from an audio signal and which is in a high frequency band greater than a predetermined crossover frequency.

2. Description of the Related Art

A high frequency signal from an audio signal is relatively less important than a low frequency signal, due to a human psychoacoustic characteristic. Thus, when the audio signal is encoded, in order to overcome a limitation in terms of the amount of usable bits and to improve coding efficiency, a method has been proposed, wherein the method performs encoding by allocating more bits to the low frequency signal and less bits to the high frequency signal. An example of the method is spectral band replication (SBR).

FIG. 1 is a diagram of conventional SBR technology.

The conventional SBR technology is based on an assumption in which there is a close relationship between a high frequency signal and a low frequency signal, which are of an audio signal. According to the conventional SBR technology, it is assumed that a high frequency band component can be predicted by using information of a low frequency band according to such a close relationship, thus, the low frequency signal is encoded by using a predetermined core codec, and with respect to the high frequency signal, only additional information, which is necessary for prediction from the low frequency signal, is encoded. Here, for the core codec, a codec based on MPEG-1 Audio Layer 3 (MP3) and Advanced Audio Coding (AAC) is used. Also, the additional information, which is used so as to reconstruct the high frequency signal, includes information about a band of the high frequency signal, wherein the low frequency signal is copied to the band of the high frequency signal.

Referring to FIG. 1, an encoder encodes a low frequency signal A 10, which is less than a predetermined crossover frequency fc and which is included in the audio signal, by using the core codec. The encoder does not directly encode a high frequency signal B 11 that is greater than the crossover frequency fc, but encodes only additional information which is necessary for prediction from the low frequency signal A 10.

A decoder receives a bitstream encoded according to such conventional SBR technology, reconstructs a low frequency signal A′ 20 by using the core codec, copies the reconstructed low frequency signal A′ 20 to a high frequency band, and adjusts a copied signal of the high frequency band by using the additional information included in the bitstream, thereby generating a high frequency signal B′ 21.

However, a method of predicting the high frequency signal from the low frequency signal and encoding the high frequency signal, such as a conventional SBR method, has a problem in that sound quality deteriorates when harmonics of the low frequency signal are stronger than the high frequency signal, or when energy variations in frequency bands of the low frequency signal are great.

Thus, with respect to encoding of a signal corresponding to a high frequency domain, there is an increasing demand for a method and an apparatus which enable the use of a small number of bits and to enhance sound quality, which is recognized by humans, as much as is possible.

### SUMMARY OF THE INVENTION

The present invention provides methods and apparatuses for efficiently encoding and decoding a high frequency component of an audio signal by using a small bit rate, without a major loss with respect to sound quality.

According to an aspect of the present invention, there is provided a method of encoding an audio signal, the method including the operations of performing linear predictive coding (LPC) analysis on a high frequency signal which is greater than a predetermined threshold frequency and which is comprised in the audio signal, and outputting an LPC coefficient and a residual signal which are of the high frequency signal; extracting gain information which indicates an amplitude variation of the residual signal; and multiplexing the LPC coefficient of the high frequency signal, and the gain information of the residual signal of the high frequency signal.

According to another aspect of the present invention, there is provided an audio signal encoding apparatus, including an LPC analysis unit performing LPC analysis on a high frequency signal which is greater than a predetermined threshold frequency and which is comprised in the audio signal, and outputting an LPC coefficient and a residual signal which are of the high frequency signal; a gain information extraction unit extracting gain information which indicates an amplitude variation of the residual signal; and a multiplexing unit multiplexing the LPC coefficient of the high frequency signal, and the gain information of the residual signal of the high frequency signal.

According to another aspect of the present invention, there is provided a method of decoding an audio signal, the method including the operations of decoding a low frequency signal of the audio signal by using a predetermined core coder; generating a residual signal of a high frequency signal of the audio signal by using the decoded low frequency signal; decoding the high frequency signal by performing LPC synthesis which uses an LPC coefficient of the high frequency signal comprised in a bitstream and uses the residual signal; and reconstructing the audio signal by integrating the decoded low frequency signal and the decoded high frequency signal.

### BRIEF DESCRIPTION OF THE DRAWINGS

The above and other features and aspects of the present invention will become more apparent by describing in detail exemplary embodiments thereof with reference to the attached drawings in which:

FIG. 1 is a diagram of conventional spectral band replication (SBR) technology;

FIG. 2 is a block diagram of an apparatus for encoding an audio signal according to an embodiment of the present invention;

FIG. 3 is a diagram for describing a time envelope of a residual signal according to an embodiment of the present invention;

FIG. 4 is a block diagram for illustrating in detail a structure of a gain information extraction unit illustrated in FIG. 2;

FIG. 5 is a flowchart of a method of encoding an audio signal, according to an embodiment of the present invention;

FIG. 6 is a block diagram of an apparatus for decoding an audio signal according to an embodiment of the present invention;

FIG. 7 is a flowchart of a method of decoding an audio signal, according to an embodiment of the present invention; and

FIG. 8 is a detailed flowchart with respect to an operation of FIG. 7, in which a residual signal of a high frequency signal of an audio signal is generated.

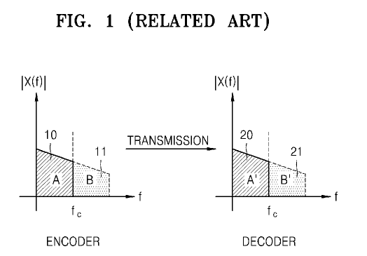

### DETAILED DESCRIPTION OF THE INVENTION

The present invention will now be described more fully with reference to the accompanying drawings, in which exemplary embodiments of the invention are shown.

The present invention provides methods and apparatuses for encoding and decoding a high frequency signal by using linear prediction coding (LPC), compared to a conventional spectral band replication (SBR) method in which a high frequency signal is generated by copying a high frequency signal based on a low frequency signal.

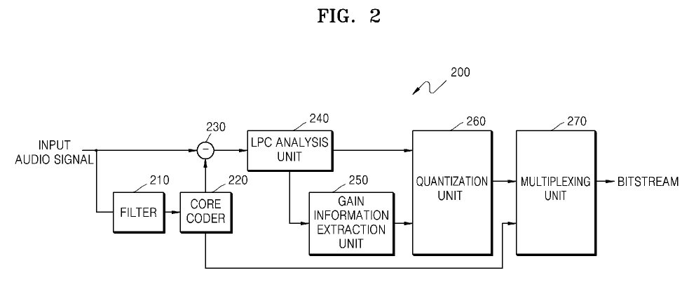

FIG. 2 is a block diagram of an apparatus for encoding an audio signal according to an embodiment of the present invention.

Referring to FIG. 2, the apparatus for encoding the audio signal (hereinafter, referred to as ‘an audio signal encoding apparatus 200’) according to the present invention includes a filter 210, a core coder 220, a subtraction unit 230, an LPC analysis unit 240, a gain information extraction unit 250, a quantization unit 260, and a multiplexing unit 270.

The filter 210 divides a received audio signal into a low frequency signal and a high frequency signal, according to a predetermined crossover frequency (that is, a threshold frequency). The core coder 220 encodes the low frequency signal, which is less than the predetermined crossover frequency, by using a core codec. Here, for the core codec, various kinds of audio compression codecs such as MPEG-1 Audio Layer 3 (MP3), Advanced Audio Coding (AAC), and the like may be used.

The LPC analysis unit 240 performs LPC analysis on the high frequency signal, which is greater than the predetermined crossover frequency and which is included in the audio signal, thereby outputting an LPC coefficient and a residual signal which are of the high frequency signal. Here, for the high frequency signal, a high frequency signal filtered via the filter 210, or a signal having a high frequency component may be used, wherein the signal is generated by subtracting the low frequency signal, which is encoded by the core coder 220 and reconstructed, from the received audio signal by using the subtraction unit 230.

The LPC analysis is a method that extracts a basic parameter of a voice, based on a linear model with respect to voice generation. LPC analysis is a method by which fundamental parameters of voice are extracted from the difference signals based on a linear model of voice generation. LPC analysis is a voice signal modeling method based on the assumption that current voice signal sample values are approximate to a linear combination of past M (where M is a positive integer) voice output sample values. The method of encoding the audio signal and the audio signal encoding apparatus 200, according to the present invention, apply such an LPC analysis to the high frequency signal which is not encoded by the core coder 220, thereby encoding the high frequency signal. The LPC analysis unit 240 extracts the LPC coefficient and the residual signal from the high frequency signal by using a covariance method, an autocorrelation method, a Lattice filter, a Levinson-Durbin algorithm, and the like, thereby outputting the LPC coefficient and the residual signal.

Specifically, the LPC analysis unit 240 assumes that s(n), that is a sample value of a current high frequency signal, is modeled by using previous p (where p is a positive integer) high frequency signal samples s(n−1), s(n−2), . . . , and s(n−p), as illustrated in Equation 1 below.

$$s ( n ) = {\sum }_{i = 1}^{p} {a}_{i} s ( n - i ) + Gu ( n ) \qquad Equation 1$$

In Equation 1, Gu(n) corresponds to a prediction error value obtained when the sample value of the current high frequency signal is predicted from the previous p high frequency signal samples according to the LPC analysis. The prediction error value is referred to as an excitation signal or a residual signal. Hereinafter, Gu(n) is referred to as the residual signal. G denotes a gain with respect to an energy of the residual signal. ai indicates the LPC coefficient. p indicates a degree of the LPC coefficient, generally having a value between 10 and 16.

When Equation 1 is transformed via the z-transform, Equation 1 becomes Equation 2 as given below.

$$H ( z ) = \frac{s ( z )}{u ( z )} = \frac{G}{1 - {\sum }_{i = 1}^{p} {a}_{i} {z}^{- 1}} = \frac{G}{A ( z )} \qquad Equation 2$$

In Equation 2, a denominator of a transfer function H(z) is indicated as A(z).

Meanwhile, the residual signal Gu(n) (may also indicated as e(n)) from Equation 1 is obtained by using Equation 3 as given below.

$$Gu ( n ) = e ( n ) = s ( n ) - {\sum }_{k = 1}^{p} {a}_{i} s ( n - k ) \qquad Equation 3$$

A transfer function of the residual signal Gu(n) corresponding to a prediction error may be obtained by using Equation 4 as given below.

$$A ( z ) = \frac{E ( z )}{S ( z )} = 1 - {\sum }_{k = 1}^{p} {a}_{k} {z}^{- k} \qquad Equation 4$$

Considering Equations 2 and 4, it is possible to understand that the transfer function of the residual signal Gu(n) corresponds to the denominator of the transfer function H(z). Thus, A(z) is decided by calculating LPC coefficients ai via the LPC analysis, and the residual signal Gu(n) is extracted by inputting the high frequency signal to A(z) and by filtering the high frequency signal.

In this manner, the LPC analysis unit 240 performs the LPC analysis with respect to the high frequency signal, outputs the LPC coefficient for generating a prediction signal of the high frequency signal, and outputs the residual signal corresponding to the prediction error.

The gain information extraction unit 250 extracts a gain value G from the residual signal and encodes the gain value G.

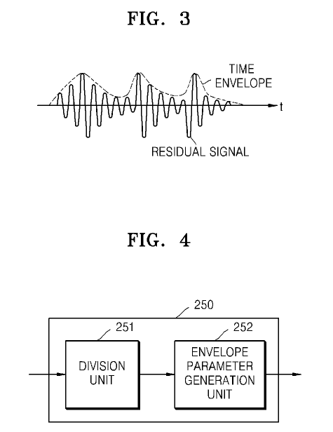

FIG. 3 is a diagram for describing a time envelope of a residual signal according to an embodiment of the present invention, and FIG. 4 is a block diagram for illustrating in detail a structure of the gain information extraction unit 250 illustrated in FIG. 2.

Referring to FIGS. 3 and 4, an amplitude variation of the residual signal may be expressed by modeling a time envelope which indicates a waveform of the residual signal. Thus, a division unit 251 included in the gain information extraction unit 250 divides the time envelope of the residual signal into units of predetermined time, and an envelope parameter generation unit 252 generates a parameter which indicates the amplitude variation of the time envelope of the residual signal by using an energy of each period of predetermined time. For example, the envelope parameter generation unit 252 may calculate an average energy of each period of predetermined time of the residual signal and may use the calculated average energy as a representative value which indicates an amplitude of each period of predetermined time.

The quantization unit 260 quantizes and outputs the LPC coefficient of the high frequency signal which is output from the LPC analysis unit 240, and quantizes and outputs gain information which is output from the gain information extraction unit 250.

The multiplexing unit 270 multiplexes encoded data of the low frequency signal, the LPC coefficient of the high frequency signal, and the gain information of the high frequency signal, thereby generating and outputting a bitstream. At this time, the multiplexing unit 270 may add various kinds of parameter information, such as degree information of the LPC coefficient and copy band information which are required in LPC synthesis procedure that is an inverse of the LPC analysis so as to reconstruct the high frequency signal, to the encoded bitstream.

In this manner, the audio signal encoding apparatus 200 encodes the high frequency signal, which is not encoded by the core coder 220, by performing the LPC analysis, thereby enhancing a coding efficiency of the high frequency signal, without greatly increasing the amount of bits.

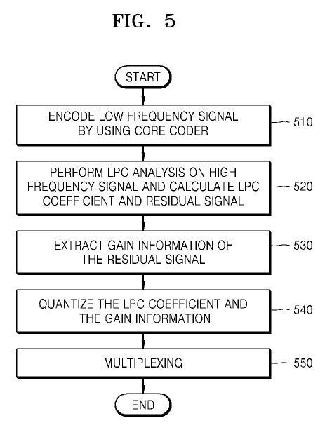

FIG. 5 is a flowchart of a method of encoding an audio signal, according to an embodiment of the present invention.

Referring to FIG. 5, in operation 510, LPC analysis is performed on a high frequency signal which is greater than a threshold frequency and which is included in the audio signal, so that an LPC coefficient and a residual signal with respect to the high frequency signal are output. As described above, for the high frequency signal, a filtered high frequency signal or a signal having a high frequency component may be used, wherein the high frequency signal is generated by subtracting a low frequency signal, which is encoded by using a core codec and reconstructed, from the received audio signal.

In operation 520, gain information indicating an amplitude variation of the residual signal is extracted. For the gain information, parameter information, which is generated by modeling a time envelope of the residual signal, may be used. In this case, the time envelope of the residual signal may be divided into units of predetermined time, and an average energy of each period of predetermined time may be calculated, so that the calculated average energy may be used as a parameter for indicating the amplitude variation of the time envelope of the residual signal.

In operation 540, quantization is performed on the LPC coefficient and the gain information of the residual signal, which are generated by performing the LPC analysis, with respect to the high frequency signal.

In operation 550, data of the encoded low frequency signal, the quantized LPC coefficient of the high frequency signal, and the quantized gain information of the residual signal of the high frequency are multiplexed. At this time, various kinds of parameter information, such as degree information of the LPC coefficient and copy band information, which are required in LPC synthesis procedure that is the inverse of the LPC analysis so as to reconstruct the high frequency signal, are added to an encoded bitstream.

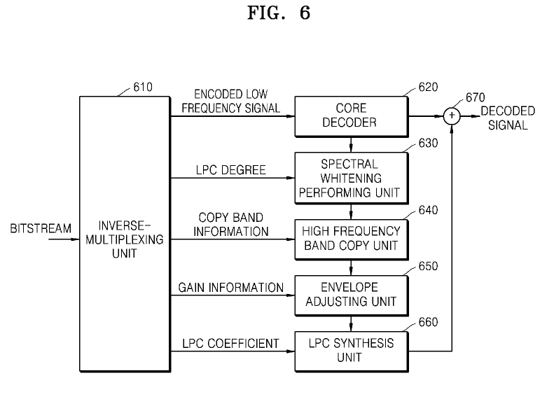

FIG. 6 is a block diagram of an apparatus for decoding an audio signal according to an embodiment of the present invention.

Referring to FIG. 6, the apparatus for decoding the audio signal (hereinafter, referred to as ‘an audio signal decoding apparatus’) according to the present invention includes an inverse-multiplexing unit 610, a core decoder 620, a spectral whitening performing unit 630, a high frequency band copy unit 640, an envelope adjusting unit 650, an LPC synthesis unit 660, and an integration unit 670. Here, the spectral whitening performing unit 630, the high frequency band copy unit 640, and the envelope adjusting unit 650 are used so as to generate a residual signal of a high frequency signal by using a decoded low frequency signal.

The inverse-multiplexing unit 610 inverse-multiplexes a bitstream, thereby extracting and outputting data of an encoded low frequency signal, and information which is required to reconstruct the high frequency signal, such as LPC coefficient degree information about an LPC coefficient, copy band information, gain information, and information about the LPC coefficient which is generated by performing LPC analysis on the high frequency signal when encoding is performed.

The core decoder 620 decodes the low frequency signal of the audio signal, wherein the low frequency signal has been encoded by using a core codec.

The spectral whitening performing unit 630 extracts a residual signal which is generated by removing an envelope from the decoded low frequency signal. For example, the spectral whitening performing unit 630 may perform the LPC analysis, thereby generating the residual signal of the decoded low frequency signal. At this time, the spectral whitening performing unit 630 may perform the LPC analysis by using an LPC coefficient degree that is equal to an encoded high frequency signal, according to the LPC coefficient degree information included in the bitstream.

The high frequency band copy unit 640 copies the residual signal of the low frequency signal to a predetermined high frequency band, wherein the residual signal is output from the spectral whitening performing unit 630. At this time, the high frequency band copy unit 640 copies the residual signal of the low frequency signal to a corresponding copy band by using the copy band information which indicates a decoded high frequency band from among high frequency bands which are greater than a predetermined crossover frequency. A high frequency signal copied from the residual signal of the low frequency signal by the high frequency band copy unit 640 corresponds to a prediction signal of the residual signal of the high frequency signal.

The envelope adjusting unit 650 divides the copied high frequency signal into units of predetermined time by using the gain information extracted from the bitstream, and adjusts an amplitude of the copied high frequency signal so that each period of predetermined time becomes equal to the gain information which corresponds to each period of predetermined time and which is extracted from the bitstream. As described above, in the case where an average energy of each period of predetermined time is used as the gain information, the amplitude of the copied high frequency signal is adjusted so that the average energy of each divided period of the copied high frequency signal becomes equal to a corresponding period's average energy which is included in the gain information. In this manner, a time envelope is adjusted by adjusting the amplitude of the copied high frequency signal according to the gain information, and thus, the residual signal of the high frequency signal is generated.

The LPC synthesis unit 660 reconstructs the high frequency signal from the LPC coefficient and the residual signal, which are of the high frequency signal and which are extracted from the bitstream, by performing the LPC synthesis that is the inverse of the LPC analysis. Referring to Equation 1, when the LPC coefficient ai and the residual signal Gu(n) are determined, the sample value of the current high frequency signal may be reconstructed from the sample value of the previous high frequency signal. Meanwhile, the LPC synthesis unit 660 may transform the LPC coefficient into line spectral frequencies (LSFs), and interpolate the LSFs, thereby performing the LPC synthesis.

The integration unit 670 integrates the low frequency signal reconstructed by the core decoder 620 and the high frequency signal reconstructed by the LPC synthesis unit 660, thereby outputting a decoded audio signal.

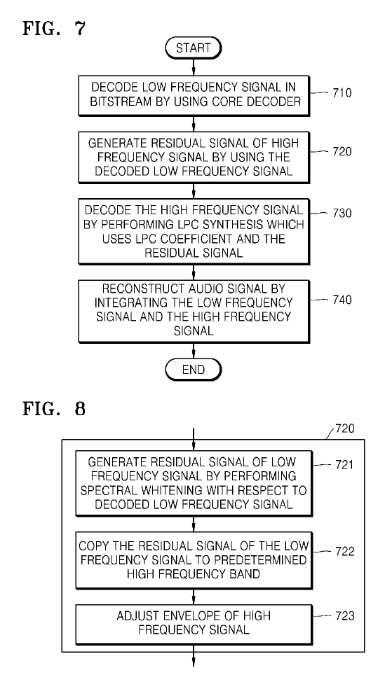

FIG. 7 is a flowchart of a method of decoding an audio signal, according to an embodiment of the present invention.

Referring to FIG. 7, in operation 710, a low frequency signal of the audio signal included in an encoded bitstream is decoded by using a core codec.

In operation 720, a residual signal of a high frequency signal of the audio signal is generated by using the decoded low frequency signal. Specifically, referring to FIG. 8, which is a detailed flowchart with respect to operation 720 of FIG. 7, in operation 721, spectral whitening is performed on the decoded low frequency signal so that a residual signal of the decoded low frequency signal is generated. As described above, an envelope may be removed from the decoded low frequency signal so that the residual signal may be generated by performing LPC analysis. In operation 722, the residual signal of the low frequency signal is copied to a predetermined high frequency band by using copy band information. In operation 723, an envelope of a signal, which is copied to the high frequency band, is adjusted by using gain information of the residual signal of the high frequency signal included in the bitstream.

Referring back to FIG. 7, in operation 730, the high frequency signal is decoded by performing LPC synthesis which uses an LPC coefficient and the residual signal which are of the high frequency signal included in the bitstream, wherein the residual signal is generated by adjusting the envelope. At this time, the LPC synthesis may be performed by transforming the LPC coefficient into LSFs and then by interpolating the LSFs.

In operation 740, the audio signal is decoded by integrating the decoded low frequency signal and the decoded high frequency signal.

The present invention may efficiently encode a tone component of the high frequency band by performing the LPC analysis with respect to the high frequency signal so that a high frequency signal component, which is not encoded in the conventional SBR method, may be encoded. Thus, sound quality of an entire audio signal is improved.

The present invention encodes the high frequency signal by performing the LPC analysis, thereby enabling the relative reduction of the amount of bits generated when the high frequency signal is encoded, and to prevent sound quality of the high frequency signal from deteriorating.

The invention can also be embodied as computer-readable codes on a computer-readable recording medium. The computer-readable recording medium is any data storage device that can store data, which can be thereafter read by a computer system.

Examples of the computer-readable recording medium include read-only memory (ROM), random-access memory (RAM), CD-ROMs, magnetic tapes, floppy disks, and optical data storage devices. In another exemplary embodiment the computer-readable recording medium includes carrier waves (such as data transmission through the Internet) and can also be distributed over network-coupled computer systems so that the computer-readable code is stored and executed in a distributed fashion.

While this invention has been particularly shown and described with reference to exemplary embodiments thereof, it will be understood by one of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of encoding an audio signal, the method comprising:
performing linear predictive coding (LPC) analysis on a high frequency signal and outputting an LPC coefficient of the high frequency signal and a residual signal of the high frequency signal, the high frequency signal having a high frequency greater than a predetermined threshold frequency and being in the audio signal;
extracting gain information which indicates an amplitude variation of the residual signal; and
multiplexing the LPC coefficient, and the gain information.

2. The method of claim 1, wherein the gain information is parameter information which is generated by modeling a time envelope of the residual signal.

3. The method of claim 1, wherein the extracting of the gain information comprises:
dividing a time envelope of the residual signal into units of predetermined time; and
generating a parameter that indicates the amplitude variation of the time envelope of the residual signal, by using an energy of each period of the units of predetermined time.

4. The method of claim 1, further comprising encoding a low frequency signal of the audio signal, excluding the high frequency signal, by using a predetermined core coder.

5. An audio signal encoding apparatus comprising:
a linear predictive coding (LPC) analysis unit which performs LPC analysis on a high frequency signal and outputting an LPC coefficient of the high frequency signal and a residual signal of the high frequency signal, the high frequency signal having a high frequency greater than a predetermined threshold frequency and being in the audio signal;
a gain information extraction unit which extracts gain information which indicates an amplitude variation of the residual signal; and
a multiplexing unit which multiplexes the LPC coefficient, and the gain information.

6. The audio signal encoding apparatus of claim 5, wherein the gain information extraction unit extracts parameter information, which is generated by modeling a time envelope of the residual signal, as the gain information.

7. The audio signal encoding apparatus of claim 5, wherein the gain information extraction unit comprises:
a division unit which divides a time envelope of the residual signal into units of predetermined time; and
an envelope parameter generation unit which generates a parameter that indicates the amplitude variation of the time envelope of the residual signal, by using an energy of each period of the units of predetermined time.

8. The audio signal encoding apparatus of claim 5, further comprising a predetermined core coder which encodes a low frequency signal of the audio signal, excluding the high frequency signal.

9. A method of decoding an audio signal, the method comprising:
decoding a low frequency signal of the audio signal by using a predetermined core coder;
generating a residual signal of a high frequency signal of the audio signal by using the decoded low frequency signal;
decoding the high frequency signal by performing linear predictive coding (LPC) synthesis which uses an LPC coefficient of the high frequency signal in a bitstream and uses the residual signal; and
reconstructing the audio signal by integrating the decoded low frequency signal and the decoded high frequency signal.

10. The method of claim 9, wherein the generating of the residual signal further comprises:
performing spectral whitening with respect to the decoded low frequency signal, and generating a residual signal of the decoded low frequency signal;
copying the residual signal of the decoded low frequency signal to a predetermined high frequency band;
adjusting an envelope of a signal, which is copied to the high frequency band, by using gain information of the residual signal of the high frequency signal in the bitstream.

11. The method of claim 10, wherein the gain information of the high frequency signal is parameter information which is generated by modeling a time envelope of the residual signal of the high frequency signal in the bitstream.

12. The method of claim 10, wherein the adjusting of the envelope comprises:
dividing the signal copied to the high frequency band into units of predetermined time; and
adjusting a time envelope of the signal copied to the high frequency band by adjusting an envelope of each period of the units of predetermined time of the signal copied to the high frequency band according to parameter information which indicates an energy of each period of a time envelope of the high frequency signal in the bitstream.

13. The method of claim 9, wherein the decoding of the high frequency signal comprises performing the LPC synthesis by transforming the LPC coefficient in the bitstream into line spectral frequencies (LSFs) and then by interpolating the LSFs.

14. An audio signal decoding apparatus comprising:
a core decoder which decodes a low frequency signal of the audio signal;
a high frequency residual signal generation unit which generates a residual signal of a high frequency signal of the audio signal by using the decoded low frequency signal;
a linear predictive coding (LPC) synthesis unit which decodes the high frequency signal by performing LPC synthesis which uses an LPC coefficient of the high frequency signal in a bitstream and uses the residual signal; and
an integration unit which reconstructs the audio signal by integrating the decoded low frequency signal and the decoded high frequency signal.

15. The audio signal decoding apparatus of claim 14, wherein the high frequency residual signal generation unit comprises:
a spectral whitening performing unit which performs spectral whitening with respect to the decoded low frequency signal, and generates a residual signal of the decoded low frequency signal;
a high frequency band copy unit which copies the residual signal of the decoded low frequency signal to a predetermined high frequency band;
an envelope adjusting unit which adjusts an envelope of a signal, which is copied to the high frequency band, by using gain information of the residual signal of the high frequency signal in the bitstream.

16. The audio signal decoding apparatus of claim 15, wherein the gain information of the high frequency signal is parameter information which is generated by modeling a time envelope of the residual signal of the high frequency signal in the bitstream.

17. The audio signal decoding apparatus of claim 15, wherein the envelope adjusting unit divides the signal copied to the high frequency band in units of predetermined time, and adjusts a time envelope of the signal copied to the high frequency band by adjusting an envelope of each period of the units of predetermined time of the signal copied to the high frequency band according to parameter information which indicates an energy of each period of a time envelope of the high frequency signal in the bitstream.

18. The audio signal decoding apparatus of claim 14, wherein the LPC synthesis unit performs the LPC synthesis by transforming the LPC coefficient in the bitstream into LSFs and then by interpolating the LSFs.
